(19) United States
(12) Patent Application Publication
(10) Pub. No.: US 2015/0382091 A1
(43) Pub. Date: Dec. 31, 2015

(54) MICROPHONE

(71) Applicant: Samsung Electro-Mechanics Co., Ltd., Suwon-Si (KR)

(72) Inventors: Byung Hun KIM, Suwon-Si (KR); Hwa Sun LEE, Suwon-Si (KR)

(73) Assignee: SAMSUNG ELECTRO-MECHANICS CO., LTD., Suwon-Si (KR)

(21) Appl. No.: 14/717,442

(22) Filed: May 20, 2015

(30) Foreign Application Priority Data
Jun. 27, 2014 (KR) 10-2014-0080017

(51) Int. Cl. H04R 1/04

(52) U.S. Cl. CPC H04R 1/04; H04R 2201/003

(57) ABSTRACT

There is provided a microphone including: a diaphragm; a support part supporting diaphragm; and a connection part connecting the diaphragm to the support part so that the diaphragm is displaceable, wherein a slit is formed in the connection part, and the slit includes a plurality of slit parts extended in different directions from each other.

### CROSS-REFERENCE TO RELATED APPLICATION

This application claims the benefit of Korean Patent Application No. 10-2014-0080017, filed on Jun. 27, 2014, entitled “Microphone” which is hereby incorporated by reference in its entirety into this application.

### BACKGROUND

The present disclosure relates to a microphone.

As portable electronic products are increased, an electrostatic type microphone manufactured by a micro electro mechanical systems (MEMS) process has been widely used.

More specifically, a microphone according to the related art including the following Related Art Document is configured of a diaphragm, which is a membrane, a back plate, a packaging structure, an application specific integrated circuit (ASIC), and other portions supporting a structure.

In addition, the back plate and the diaphragm are installed so as to have a predetermined distance therebetween, and when a voltage potential is applied to the microphone, the microphone is charged with electric charges, thereby having capacitance.

Further, when a sound wave is transferred to the diaphragm, the diaphragm is deformed by pressure of the sound wave, which changes the distance between the diaphragm and the back plate and causes a change ΔC in a capacitance value. ΔC is electrically measured, such that the sound wave is converted into an electric signal.

As described above, the microphone according to the related art is implemented in a manner in which ΔC is generated by distance displacement between the diaphragm and the back plate, and thus, the sound wave is converted into the electric signal, but it is difficult to more efficiently implement the microphone in this manner.

### RELATED ART DOCUMENT

### Patent Document

(Patent Document 1) U.S. Pat. No. 6,535,460

### SUMMARY

An aspect of the present disclosure may provide a microphone of which performance is improved by improving a displacement amount of a diaphragm.

According to an aspect of the present disclosure, a microphone may include: a diaphragm; a support part supporting the diaphragm; and a connection part connecting the diaphragm to the support part so that the diaphragm is displaceable, wherein a slit is formed in the connection part, and the slit includes a plurality of slit parts extended in different directions from each other.

According to another aspect of the present disclosure, a microphone may include: a diaphragm; a support part supporting the diaphragm; and a connection part connecting the diaphragm to the support part so that the diaphragm is displaceable, wherein a slit is formed in the connection part, and the slit is composed of a plurality of slit parts formed alternately with each other.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a partial perspective view schematically showing a microphone according to a first exemplary embodiment of the present disclosure;

FIG. 2 is a partial cross-sectional view schematically showing the microphone according to the first exemplary embodiment of the present disclosure;

FIG. 3 is partial plan view a schematically showing the microphone shown in FIG. 1;

FIGS. 4A and 4B are schematic views of a usage state of the microphone shown in FIG. 1;

FIG. 5 is a graph schematically showing displacement depending on the usage state of the microphone according to the first exemplary embodiment of the present disclosure;

FIG. 6 is a partial plan view schematically showing a microphone according to a second exemplary embodiment of the present disclosure; and

FIG. 7 is a partial plan view schematically showing a microphone according to a third exemplary embodiment of the present disclosure.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

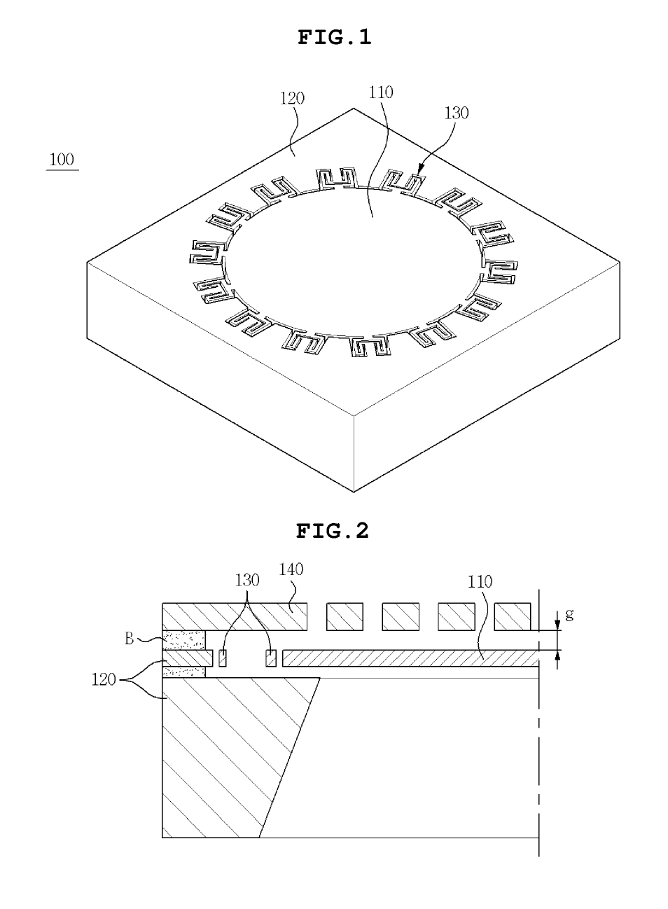

FIG. 1 is a partial perspective view schematically showing a microphone according to a first exemplary embodiment of the present disclosure, and FIG. 2 is a partial cross-sectional view schematically showing the microphone according to the first exemplary embodiment of the present disclosure.

As shown, the microphone 100 includes a diaphragm 110, a support part 120, and connection parts 130. In addition, the microphone 100 may be configured to further include a back plate 140 positioned so as to face the diaphragm 110 as shown in the partial cross-sectional view of FIG. 2.

More specifically, the diaphragm 110 is displaceably coupled to the support part 120 by the connection part 130. That is, the connection part 130 connects the diaphragm 110 and the support part 120, such that the support part supports the diaphragm. In addition, the connection part is formed so as to improve displacement of the diaphragm 110 and implement linear displacement.

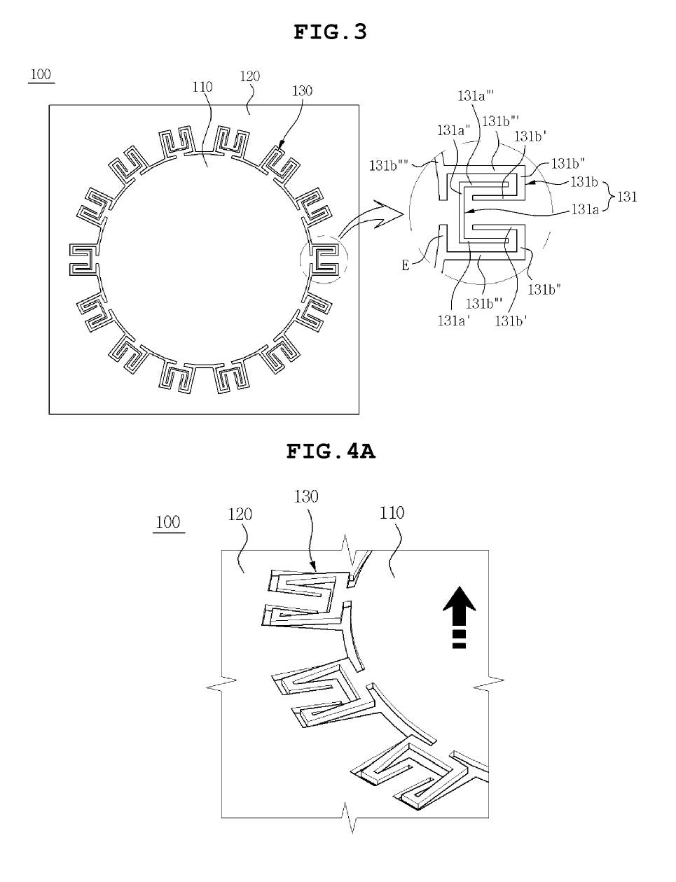

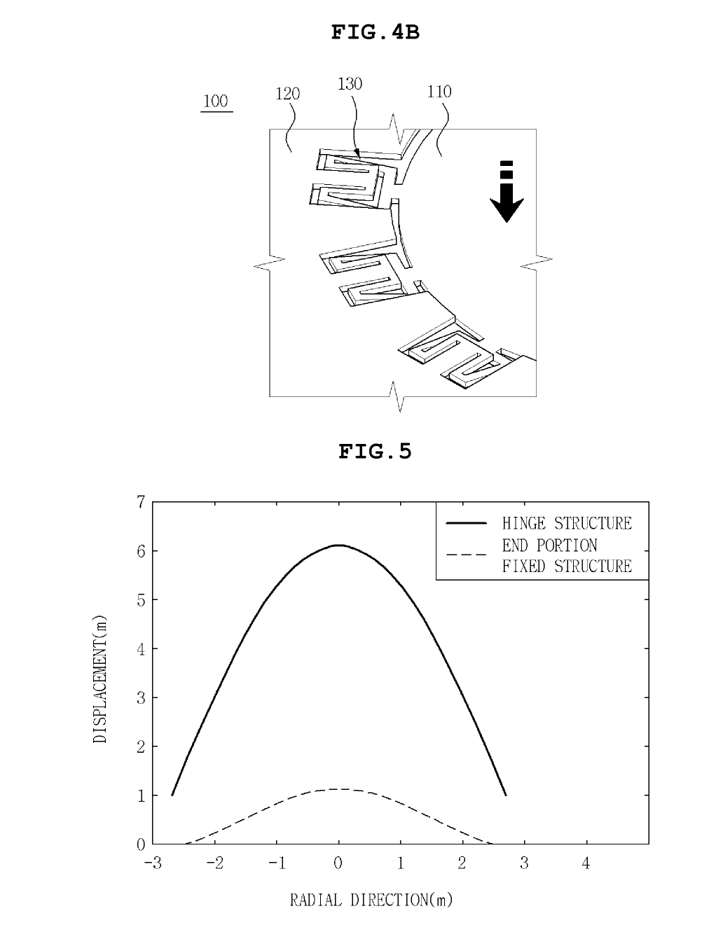

To this end, the connection part 130 of the microphone according to the first exemplary embodiment of the present disclosure has special shape, structure, and functions, and a detailed description thereof will be provided with reference to FIGS. 3 to 4B.

Meanwhile, in the case in which a sound wave is applied thereto from the outside, the microphone 100 is displaced, and the sound wave is converted into an electric signal by detecting a change in capacitance through distance displacement between the diaphragm 110 and the back plate 140.

To this end, the diaphragm 110, which is to be displaced by the sound wave, may be made of a disk type thin film. In addition, the diaphragm 110 may have conductivity and be formed so that a conductive part is formed at least some thereof.

Further, a conductive part may be formed in the back plate 140 so as to face the diaphragm 110 or the conductive part of the diaphragm.

In addition, the diaphragm 110 and the back plate 140 may be disposed apart from each other so as to have a predetermined distance g therebetween, and the diaphragm 110, the support part 120, and the back plate 140 may be coupled to each other by a bonding material B as shown in FIG. 2.

Hereinafter, in the microphone according to the first exemplary embodiment of the present disclosure, the shape, the structure, and the function of the connection part 130 connecting the diaphragm 110 and the support part 120 will be described in more detail.

FIG. 3 is partial plan view a schematically showing the microphone shown in FIG. 1. As shown in FIG. 3, a slit 131 is formed in the connection part 130 of the microphone 100.

In addition, the slit 131 is to decrease rigidity of the connection part 130 to increase displacement of the diaphragm 110. To this end, the silt 131 may be composed a plurality of slit parts extended in different directions from each other. As an example, the slit 131 of the connection part 130 shown in FIGS. 1 to 3 includes internal and external slits 131a and 131b, and the internal slit 131a may be formed so as to be covered by the external slit 131b.

In addition, the internal slit 131a may be formed so as to be partially symmetric to the external slit 131b.

Further, the internal slit 131a may be composed of a first internal slit part 131a′, a second internal slit part 131a″, and a third internal slit part 131a′″ which are extended in different directions from each other.

In addition, the first and third internal slit parts 131a′ and 131a′″ may be extended in the same direction as a direction in which the connection part 130 connects the diaphragm 110 and the support part 120 to each other. Further, the second internal slit part 131a″ may connect the first and third internal slit parts 131a′ and 131a′″ to each other and be extended in a direction orthogonal to the direction in which the connection part 130 connects the diaphragm 110 and the support part 120 to each other.

Then, the external slit 131b may be composed of a first external slit part 131b′, a second external slit part 131b″, and a third external slit part 131b′″ which are extended in different directions from each other.

Further, the external slit 131b may be formed of a pair of external slits symmetric to each other based on the direction in which the connection part 130 connects the diaphragm 110 and the support part 120 to each other.

In addition, the first and third external slit parts 131b′ and 131b′″ may be extended in the direction in which the connection part 130 connects the diaphragm 110 and the support part 120 to each other. Further, the second external slit part 131b″ may connect the first and third external slit parts 131b′ and 131b′″ to each other and be extended in the direction orthogonal to the direction in which the connection part 130 connects the diaphragm 110 and the support part 120 to each other.

In addition, as described above, the external and internal slits 131b and 131a may be formed to be symmetric to each other. That is, as shown in an enlarged view of FIG. 3, the first and second internal slit parts 131a′ and 131a″ may be formed so as to be symmetric to the first and second external slit parts 131b′ and 131b″, respectively, and the third internal slit part 131a′″ may be formed so as to be symmetric to the first external slit part 131b′.

Further, the external slit 131b may be configured to further include a connection slit 131b″″ so as to be connected to an external slit of a connection part adjacent thereto.

In addition, the connection slit 131b″″ may be extended inwardly of the connection part 130 so that a connection area between the connection part 130 and the diaphragm 110 is decreased (an extended portion of the connection slit 131b″″ is represented by E in the enlarged view of FIG. 3).

A plurality connection parts 130 composed as described above may be disposed at equidistance so as to connect the diaphragm 110 and the support part 120 to each other.

FIGS. 4A and 4B are schematic views of a usage state of the microphone shown in FIG. 1, and FIG. 5 is a graph schematically showing displacement depending on the usage state of the microphone according to the first exemplary embodiment of the present disclosure.

As shown in FIGS. 4A to 5, in the microphone 100, the diaphragm 110 is displaced by sound pressure. FIG. 4A shows that the diaphragm 110 is displaced in one direction, and FIG. 4B shows that the diaphragm 110 is displaced in the other direction.

More specifically, the diaphragm 110 is displaced by sound pressure in a state in which the diaphragm is displaceably coupled to the support part by the connection part 130. In this case, as shown in the graph of FIG. 5, the largest displacement is generated at a central portion of the diaphragm.

Further, the connection part 130 supporting the diaphragm 110 catches an end portion of the diaphragm 110 and performs a hinge function of freely generating displacement through the special shape and structure as described above.

Therefore, displacement of the diaphragm 110 is linearly increased from the end portion thereof coupled to the connection part 130 toward the central portion thereof, which may be confirmed through the graph shown in FIG. 5.

In addition, as shown in FIG. 5, it may be confirmed that as the connection part 130 of the microphone 100 according to the first exemplary embodiment of the present disclosure has the special structure and shape (hinge structure: shown as a solid line), displacement at the central portion of the diaphragm is increased about 5 times than that of a diaphragm having a fixed end portion according to the related art (shown as a dotted line).

Further, sensitivity of the microphone is defined as follows.

$$Sensitivity = \frac{{V}_{bias}}{g} \cdot \frac{Δ g}{Δ P}$$

Here, V_{bias} refers to as a bias voltage,

g refers to a distance between the diaphragm and the back plate,

Δg refers to displacement of g, and

Δp refers to an applied pressure.

Therefore, in order to improve sensitivity of the microphone, there is a need to increase Vbias or to decrease g, wherein V_{bias} and g correspond to first items in Equation. However, in this case, electro-static force is also increased, such that there is a limitation in improving sensitivity.

As a result, sensitivity may be improved by increasing a displacement amount of the diaphragm, which is Δg in comparison to the applied pressure corresponding to second items in Equation, and in the diaphragm according to the first exemplary embodiment of the present disclosure, the displacement amount, which is Δg, is improved, such that performance of the microphone is improved.

In addition, as the displacement amount is increased, the microphone is operated at low sound pressure up to high sound pressure, such that efficiency may be improved. Further, in a radial direction of the diaphragm, the displacement amount is linearly increased from the end portion toward the central portion, such that reliability may also be secured.

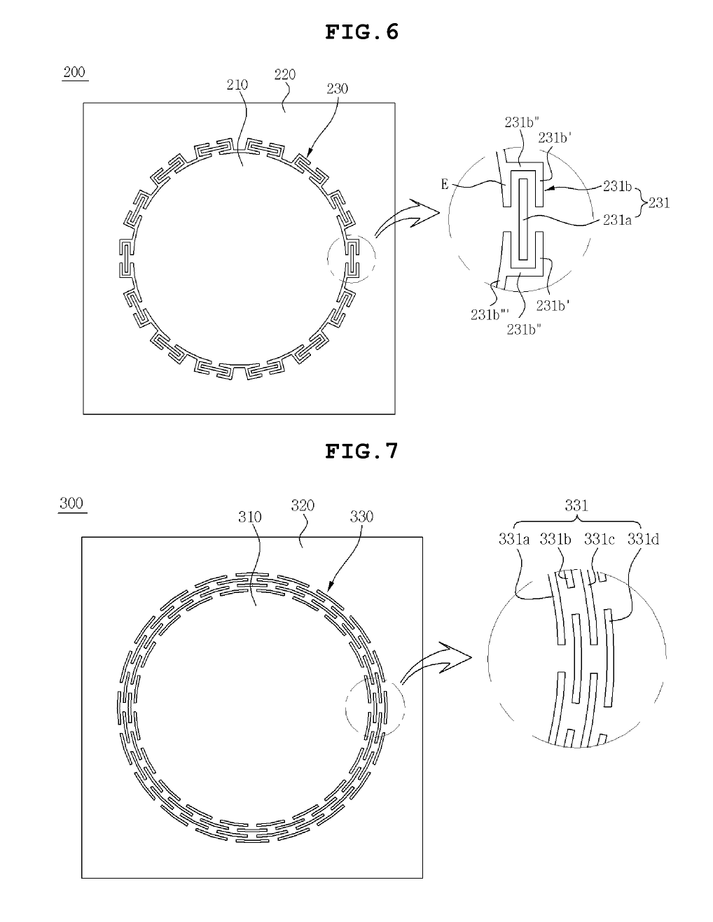

FIG. 6 is a partial plan view schematically showing a microphone according to a second exemplary embodiment of the present disclosure. As shown in FIG. 6, in a microphone 200, only a connection part is different from that of the microphone 100 according to the first exemplary embodiment of the present disclosure as shown in FIG. 1.

More specifically, the microphone 200 includes a diaphragm 210, a support part 220, and a connection part 230. In addition, the microphone 200 may be configured to further include a back plate (not shown, see 140 of FIG. 2) positioned so as to face the diaphragm 210.

Further, a slit 231 is formed in the connection part 230. In addition, the slit 231 is to decrease rigidity of the connection part 230 to increase displacement of the diaphragm 210. To this end, the slit 231 is composed of a plurality of slit parts, and the slit 231 of the connection part 230 includes internal and external slits 231a and 231b.

Further, the internal slit 231a may be extended in a direction orthogonal to a direction in which the connection part 230 connects the diaphragm 210 and the support part 220 to each other.

Then, the external slit 231b may be composed of a first external slit part 231b′ and a second external slit part 231b″ which are extended in different directions from each other.

Further, the external slit 231b may be formed of a pair of external slits symmetric to each other based on the direction in which the connection part 230 connects the diaphragm 210 and the support part 220 to each other.

In addition, the first external slit part 231b′ is extended in the direction orthogonal to the direction in which the connection part 230 connects the diaphragm 210 and the support part 220 to each other.

That is, the first external slit part 231b′ is formed in the same direction as the direction in which the internal slit 231a is formed, so as to be closer to the support part 220 than the internal slit 231a.

In addition, the second external slit parts 231b″ may be connected to the first external slit part 231b′ and extended in the direction in which the connection part 230 connects the diaphragm 210 and the support part 220 to each other.

Further, the external slit 231b may be configured to further include a connection slit 231b′″ so as to be connected to an external slit of a connection part adjacent thereto.

In addition, the connection slit 231b′″ may be extended inwardly of the connection part 230 so that a connection area between the connection part 230 and the diaphragm 210 is decreased (an extended portion of the connection slit 231b′″ is represented by E in the enlarged view of FIG. 6).

In addition, the second external slit part 231b″ is formed at the outside of the internal slit 231a and the external slit 231b is formed so as to cover the internal slit 231a as shown in the enlarged view of FIG. 6.

A plurality of connection parts 230 of the microphone 200 according to the second exemplary embodiment of the present disclosure composed as described above may be disposed at equidistance so as to connect the diaphragm 210 and the support part 220 to each other.

FIG. 7 is a partial plan view schematically showing a microphone according to a third exemplary embodiment of the present disclosure.

As shown in FIG. 7, in a microphone 300, only a connection part is different from that of the microphone 100 according to the first exemplary embodiment of the present disclosure as shown in FIG. 1.

More specifically, the microphone 300 includes a diaphragm 310, a support part 320, and a connection part 330. In addition, the microphone 300 may be configured to further include a back plate (not shown, see 140 of FIG. 2) positioned so as to face the diaphragm 310.

Further, a slit 331 is formed in the connection part 330. In addition, the slit 331 is to decrease rigidity of the connection part 330 to increase displacement of the diaphragm 310, and the slit 331 is composed of a plurality of slit parts.

Further, the slit 331 of the connection part 330 includes a first slit part 331a, a second slit part 331b, a third slit part 331c, and a fourth slit part 331d, and a plurality of slits 331 are arrayed in a circumferential direction of the diaphragm.

Further, the first slit part 331a, the second slit part 331b, the third slit part 331c, and the fourth slit part 331d may be extended in a direction orthogonal to a direction in which the connection part 330 connects the diaphragm 310 and the support part 320 to each other. That is, the case in which the diaphragm 310 is formed in a disk shape is shown by way of example in FIG. 7, and in the case in which the diaphragm 310 is formed in the disk shape as described above, the first slit part 331a, the second slit part 331b, the third slit part 331c, and the fourth slit part 331d of the connection part 330 may be extended in the circumferential direction.

In addition, the first slit part 331a, the second slit part 331b, the third slit part 331c, and the fourth slit part 331d may be formed so as to be sequentially adjacent to the diaphragm, and may be formed so that formation positions thereof are alternated with each other as shown in the enlarged view of FIG. 7. That is, the first slit part 331a, the second slit part 331b, the third slit part 331c, and the fourth slit part 331d may be formed so that the formation positions thereof are partially overlapped with each other in one direction, the first slit part 331 and the third slit part 331c face each other, and the second slit part 331b and the fourth slit part 331d face each other.

A plurality of connection parts 330 of the microphone 300 according to the third exemplary embodiment of the present disclosure composed as described above may be disposed at equidistance so as to connect the diaphragm 310 and the support part 320 to each other.

In the microphones according to the first to third exemplary embodiments of the present disclosure, the connection part and the diaphragm may be formed integrally with each other and then, the slit part may be formed, or the support part, the diaphragm, and the connection part are integrally with each other, and then, the slit part may be formed.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. A microphone comprising:
a diaphragm;
a support part supporting the diaphragm; and
a connection part connecting the diaphragm to the support part so that the diaphragm is displaceable,
wherein a slit is formed in the connection part, and the slit includes a plurality of slit parts extended in different directions from each other.

2. The microphone of claim 1, wherein the slit includes internal and external slits, and the external slit is formed so as to cover the internal slit.

3. The microphone of claim 2, wherein the internal slit is formed so as to be partially symmetric to the external slit.

4. The microphone of claim 2, wherein the internal slit is composed of a first internal slit part, a second internal slit part, and a third internal slit part which are extended in different directions from each other.

5. The microphone of claim 4, wherein the first and third internal slit parts are extended in a direction in which the connection part connects the diaphragm and the support part to each other, and the second internal slit part connects the first and third internal slit parts to each other.

6. The microphone of claim 5, wherein the second internal slit part is extended in a direction orthogonal to the direction in which the connection part connects the diaphragm and the support part to each other.

7. The microphone of claim 2, wherein the external slit is composed of a first external slit part, a second external slit part, and a third external slit part which are extended in different directions from each other.

8. The microphone of claim 7, wherein the external slit is formed of a pair of external slits symmetric to each other based on a direction in which the connection part connects the diaphragm and the support part to each other.

9. The microphone of claim 7, wherein the first and third external slit parts are extended in a direction in which the connection part connects the diaphragm and the support part to each other, and the second external slit part connects the first and third external slit parts to each other.

10. The microphone of claim 7, wherein the second external slit part is extended in a direction orthogonal to a direction in which the connection part connects the diaphragm and the support part to each other.

11. The microphone of claim 7, wherein the external slit further includes a connection slit connected to an external slit of a connection part adjacent thereto.

12. The microphone of claim 2, wherein the internal slit is extended in a direction orthogonal to a direction in which the connection part connects the diaphragm and the support part to each other, and the external slit is formed so as to cover the internal slit.

13. The microphone of claim 12, wherein the external slit is composed of a first external slit part and a second external slit part which are extended in different directions from each other, and formed of a pair of external slits symmetric to each other based on the direction in which the connection part connects the diaphragm and the support part to each other.

14. The microphone of claim 13, the first external slit part is extended in the direction orthogonal to the direction in which the connection part connects the diaphragm and the support part to each other, the second external slit part is connected to the first external slit part, and the connection part is extended in the direction in which the connection part connects the diaphragm and the support part to each other.

15. A microphone comprising:
a diaphragm;
a support part supporting the diaphragm; and
a connection part connecting the diaphragm to the support part so that the diaphragm is displaceable,
wherein a slit is formed in the connection part, and the slit is composed of a plurality of slit parts formed alternately with each other.

16. The microphone of claim 15, wherein the slit is extended in a direction orthogonal to a direction in which the connection part connects the diaphragm and the support part to each other, and includes a first slit part, a second slit part, a third slit part, and a fourth slit part which are formed to be sequentially adjacent to the diaphragm.

17. The microphone of claim 16, wherein the first and third slit parts are formed so as to face each other, and the second and fourth slit parts are formed so as to face each other.

18. The microphone of claim 17, wherein in one direction, the first and second slit parts are partially overlapped with each other, the second and third slit parts are partially overlapped with each other, and the third and fourth slit parts are partially overlapped with each other.
